(19) United States
(12) Patent Application Publication
(10) Pub. No.: US 2010/0299010 A1
(43) Pub. Date: Nov. 25, 2010

(54) METHOD OF ENERGY MANAGEMENT IN A MOTOR VEHICLE

(75) Inventor: Richard Balmy, Puteaux (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Renault S.A.S, Boulogne-Billancourt (FR)

(21) Appl. No.: 12/741,528

(22) PCT Filed: Oct. 31, 2008
(86) PCT No.: PCT/FR2008/051972

§ 371 Date: Jul. 12, 2010

(30) Foreign Application Priority Data
Nov. 5, 2007 (FR) 0758801

(51) Int. Cl. G06F 19/00

(52) U.S. Cl. 701/22

(57) ABSTRACT

A method of energy management in a motor vehicle including an electric traction system supplied by at least one battery, and an electrical energy source which is auxiliary to the battery and which is able to supplement power provided by the battery to supply the electric traction system, the auxiliary source being associated with a fuel reservoir. The method controls a power level provided by the auxiliary electrical energy source when it is activated, selected exclusively from a first low power level and a second high power level, according to a sign of a difference calculated between variation of a reservoir filling state and variation of a battery charge state, the first and second power levels making it possible to limit energy losses associated with conversion of the fuel into electrical energy by the auxiliary electrical energy source.

The present invention relates to a method of energy management in a motor vehicle comprising an electric traction system powered by at least one battery and a supplementary electric energy source able to complement the energy supplied by the battery to power the electric traction system and which has an associated fuel tank feeding said electric energy source.

These days, helping to reduce CO₂ emissions and therefore control the greenhouse effect has become a major issue for the motor vehicle industry. Such is the backdrop against which vehicles driven by electric energy have achieved their rapid growth.

The current battery-powered electric vehicles have reduced ranges compared to conventional heat-engine vehicles.

Thus, the motor vehicle industry is focused on the development of “range extender” electric vehicles, provided with an electric energy source supplementing the battery and capable of complementing the electric energy supplied by the latter, thus increasing the range of the vehicle.

This supplementary electric energy source may consist of an internal combustion engine coupled with an alternator, a fuel cell supplied directly with hydrogen, a fuel cell coupled to a reforming system supplied with fossil fuel, or any other system that can produce electric energy.

There is then a need to effectively control the distribution of the various electric energy sources to supply the electric power necessary to the vehicle while maximizing its range.

With this objective in mind, the method that is the subject of the invention, also conforming to the generic definition given in the above preamble, is essentially characterized in that it comprises the determination of the activation or non-activation of the supplementary electric energy source and, in case of activation, the control of the latter for it to supply an electric power level chosen exclusively from a first low power level and a second high power level, according to the sign of the difference calculated between the variation of a tank fullness state and the variation of a battery charge state, the first and second power levels being defined in such a way as to limit the energy losses associated with the conversion of the fuel into electric energy by the supplementary electric energy source.

Advantageously, the first low power level is chosen if the difference is negative and the second high power level is chosen if said difference is positive.

According to one embodiment, the variation of a tank fullness state comprises the determination of a first ratio between a current tank fullness state and an initial tank fullness state upon the activation of the supplementary electric energy source, and in that the variation of the battery charge state comprises the determination of a second ratio between a current battery charge state and an initial battery charge state upon the activation of the supplementary electric energy source.

Preferentially, the determination of the variation of the battery charge state takes account of a battery minimum charge threshold.

Advantageously, the supplementary electric energy source is used to recharge the battery if the electric power level supplied by said supplementary electric energy source is greater than the electric power required by the electric traction system.

According to one embodiment, the method according to the invention is coupled with a motor vehicle navigation system and in that the determination of the activation of the supplementary electric energy source and the control of the latter take account of parameters supplied by the vehicle navigation system.

Advantageously, the parameters supplied by the navigation system comprise at least one of the following parameters taken from a vehicle arrival point, an itinerary defined for the vehicle, and information identifying areas with restricted pollutant emissions along said itinerary.

According to various embodiments, the supplementary electric energy source comprises an internal combustion engine coupled to an alternator, or a fuel cell supplied directly with hydrogen, or a fuel cell coupled to a reforming system.

Advantageously, the electric traction system comprises an electric machine able to function in motor mode and in generator mode.

Other features and advantages of the present invention will become more clearly apparent on reading the following description, given by way of illustrative and nonlimiting example, and with reference to the appended figures in which:

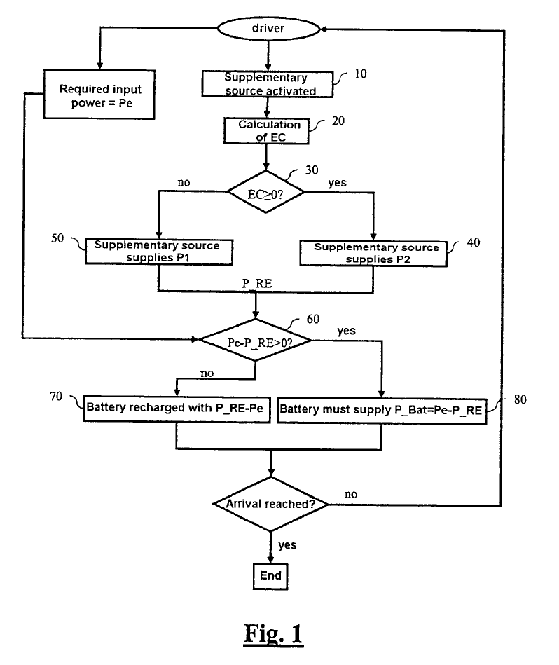

FIG. 1 is a flow diagram illustrating a first embodiment of the energy management method according to the invention, and

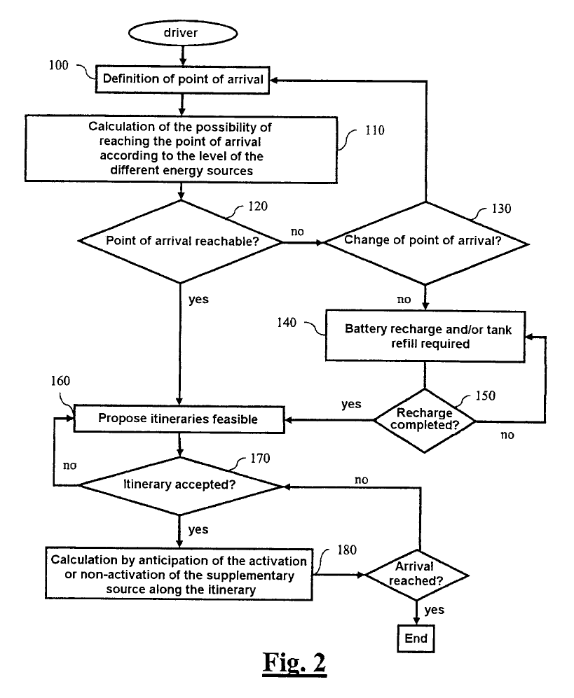

FIG. 2 is a flow diagram illustrating a second embodiment of the energy management method according to the invention, with coupling with a motor vehicle navigation system.

The object of the present invention is therefore to propose a method with which to control the operation of the supplementary electric energy source of the electric vehicle, also having an electric battery system to supply the energy to the vehicle's electric traction system. The vehicle's electric traction system conventionally comprises an electric machine capable of operating, on the one hand, in motor mode and, on the other hand, in generator mode, then being driven by the wheels of the vehicle.

According to one principle of the invention, the supplementary electric energy source of the vehicle is adapted to be able to operate at two different power levels, respectively a first low level P1 and a second high level P2, considered relative to one another.

Furthermore, these two power levels each correspond to an efficiency-optimized operating point of the supplementary electric energy source. More specifically, by having the supplementary electric energy source operate on these optimized operating points, respectively P1 and P2, the losses associated with the conversion of the fuel supplying the supplementary electric energy source with electric energy can be minimized.

According to the invention, the supplementary electric energy source is designed to operate only on these two operating points. In other words, it will be controlled so as to supply an electric power level chosen exclusively from the first low power level P1 and the second high power level P2.

The present invention also relies on the principle according to which the maximum range of the vehicle will be obtained when the use of the battery and the use of the tank supplying the supplementary electric energy source are even and proportional, so as to empty the available fuel at the same time as the battery.

To put this energy management law into place, it is necessary to have a system that is capable to determining the current charge state of the battery, and the current fullness state of the tank supplying the supplementary electric energy source with fuel. These two states will be expressed as percentages. Thus:

R: the current fullness state of the tank supplying the supplementary electric energy source, and

B: the current battery charge state.

At the moment when the supplementary electric energy source is activated, provision is also made to measure the instantaneous initial battery charge and tank fullness states. These two states will also be expressed as percentages, and:

R0: initial fullness state of the tank supplying the supplementary electric energy source when the latter is activated, and

B0: the initial battery charge state when the supplementary electric energy source is activated.

The aim is therefore to keep the ratio R/R0, representative of the variation of the fullness state of the tank supplying the supplementary electric energy source with fuel, close to the ratio B/B0, representative of the variation of the battery charge state.

The choice of one or other of the two efficiency-optimized operating powers P1 and P2 of the supplementary electric energy source will then be dependent on the sign of the difference calculated between the first ratio R/R0 and the second ratio B/B0.

According to one embodiment, for battery reliability issues, it may be desirable for the charge state not to fall below a minimum charge threshold, 30% for example, while emptying the tank. Provision is then made to put in place a regulation system that can take account of a minimum battery charge threshold, by keeping the ratio R/R0 close to (B−X/100)/(B0−X/100), X being the minimum battery charge threshold.

The flow diagram supplied as an example in FIG. 1 illustrates precisely this case.

Thus, a step 10 of activation of the supplementary electric energy source, initiated by the driver, is first implemented. The driver in effect decides to activate or not activate the vehicle's supplementary electric energy source. If said source is not activated, the vehicle will then remain in pure electric mode. If, on the other hand, it is activated, the self-adaptive management law according to the invention is implemented, making it possible to decide on the operating points P1 and P2 at which the supplementary electric energy source will be invoked, so as to maximize the range of the vehicle.

For this, a step 20 is implemented which consists in calculating the difference EC=R/R0−(B−X/100)/(B0−X/100).

There then follows a step 30 consisting in determining the sign of this difference. If said sign is positive, this means that the battery is draining more quickly than the tank supplying the supplementary electric energy source with fuel. In this situation, a choice will be made, in a step 40, to have the supplementary electric energy source operate in such a way that it supplies an electric power level P_RE corresponding to its efficiency-optimized predefined high power level P2.

If EC is negative, this means, on the other hand, that the tank supplying the supplementary electric energy source with fuel is draining more quickly than the battery and that the latter is therefore not being invoked enough. A choice is therefore made, in a step 50, to have the supplementary electric energy source operate in such a way that it supplies an electric power level P_RE corresponding to efficiency-optimized predefined low power level P1.

A hysteresis is preferentially added to the transition thresholds P1 and P2, so as to limit the transition of the supplementary electric energy source from one operating level to another.

In a step 60, the electric power Pe required as input for the vehicle's electric traction system is then compared with the power level P_RE supplied by the supplementary electric energy source.

If the electric power level P_RE supplied by the supplementary electric energy source is greater than the electric power Pe required as input by the electric traction system (Pe−P_RE<0), the supplementary electric energy source is also used in a step 70 to recharge the battery. The latter is then recharged with the power P_RE−Pe.

Otherwise, if the electric power level P_RE supplied by the supplementary electric energy source is less than the electric power Pe required as input by the electric traction system (Pe−P_RE>0), the battery must then, in a step 80, supply a power P_Bat=Pe−P_RE.

The steps 10 to 80 described previously are then repeated until the final destination of the vehicle is reached.

One of the advantages of the method according to the invention as just described is that it prevents the supplementary electric energy source from excessively recharging the battery, thus limiting the losses associated with the transfer of the electric energy into chemical energy. This also makes it possible to maximize the benefit from the regenerative braking effects when the vehicle's electric traction system is operating in generator mode.

The method as has just been described can also be coupled with a vehicle navigation system, as illustrated by the flow diagram of FIG. 2. Thus, the determination of the activation of the supplementary electric energy source and the control of the latter can advantageously take account of the parameters supplied by the vehicle navigation system.

According to the flow diagram illustrated in FIG. 2, before starting, in a step 100, the driver programs a point of arrival via the navigation system. Then, in a step 110, the possibility of reaching or not reaching the programmed point of arrival is calculated according to the level of the different energy sources of the vehicle and the consumption of the vehicle during the journey.

In the step 120, if the point of arrival is not reachable, the driver will be prompted via a human-machine interface to modify his point of arrival in the step 130. Otherwise, in a step 140, the driver will be prompted to fill the tank supplying the supplementary electric energy source and/or recharge the battery, up to a certain level, so as to enable the vehicle to reach the point of arrival.

If the point of arrival has been calculated as being reachable in the step 120 or if the recharging of the battery and/or the refilling of the tank requested in the step 140 has actually been done in the step 150 to make the point of arrival reachable, a certain number of itineraries that are feasible for reaching the point of arrival are proposed to the driver via the navigation system in a step 160.

Once an itinerary has been chosen by the driver in the step 170, a step 180 implements an advance calculation of the total energy that the vehicle will need, so as to decide on the moments when the supplementary electric energy source will be activated or not along the chosen itinerary and at which power level it will operate according to the principles already explained above.

This calculation of the activation or non-activation of the supplementary electric energy source and of the choice of its power level along the chosen itinerary via the navigation system can also take account of various regulatory constraints, such as the limiting of polluting emissions in certain areas along the chosen itinerary.

In practice, if the itinerary planned by the navigation system plans for a passage into an area with restricted polluting emissions, the energy management law will activate or not activate the supplementary electric energy source, so as to enable the vehicle to reach its point of arrival while observing the regulations, by reaching the area with restricted polluting emissions with a state of charge of the battery enabling it to pass through that area.

The strategy of optimized distribution of the use of the various vehicle energy sources can also take account of battery ageing characteristics. In principle, the life of the battery will be altered to a greater or lesser degree depending on the demands made of it. Parameters such as charge state variations, recharging or discharging profile, will affect its life. These parameters can be incorporated into the energy management law so that they can be observed to the maximum. For example, if, to minimize the ageing of the battery, it is recommended to store it with a 50% charge level and the user parks his vehicle with a battery with 30% charge state, the supplementary electric energy source will be started up to recharge the battery and thus limit its ageing. According to another example, if, to limit the ageing of the battery, the latter must operate within a charge state range of between 50 and 30%, the supplementary electric energy source will be controlled so that the battery operates by remaining within this operating range.

1-9. (canceled)

10. A method of energy management in a motor vehicle including an electric traction system powered by at least one battery and an electric energy source supplementing the battery, configured to complement electric power supplied by the battery to power the electric traction system and which has an associated fuel tank feeding the electric energy source, the method comprising:
determining activation or non-activation of the supplementary electric energy source and, in a case of activation, controlling the supplementary electric energy source to supply an electric power level chosen exclusively from a first low power level and a second high power level, according to a sign of a difference calculated between a variation of a tank fullness state and a variation of a battery charge state, the first and second power levels being defined to limit energy losses associated with conversion of the fuel into electric energy by the supplementary electric energy source.

11. The method as claimed in claim 10, wherein the first low power level is chosen if the difference is negative and the second high power level is chosen if the difference is positive.

12. The method as claimed in claim 10, wherein the variation of a tank fullness state comprises determination of a first ratio between a current tank fullness state and an initial tank fullness state upon activation of the supplementary electric energy source, and the variation of the battery charge state comprises determination of a second ratio between a current battery charge state and an initial battery charge state upon the activation of the supplementary electric energy source.

13. The method as claimed in claim 12, wherein the determination of the variation of the battery charge state takes account of a battery minimum charge threshold.

14. The method as claimed in claim 10, wherein the supplementary electric energy source is used to recharge the battery if the electric power level supplied by the supplementary electric energy source is greater than electric power required by the electric traction system.

15. The method as claimed in claim 10, coupled with a motor vehicle navigation system, and wherein the determination of the activation of the supplementary electric energy source and control of the supplementary electric energy source takes account of parameters supplied by the vehicle navigation system.

16. The method as claimed in claim 15, wherein the parameters supplied by the navigation system comprise at least one of:
a vehicle arrival point;
an itinerary defined for the vehicle; and
information identifying areas with restricted pollutant emissions along the itinerary.

17. The method as claimed in claim 10, wherein the supplementary electric energy source comprises an internal combustion engine coupled to an alternator, or a fuel cell supplied directly with hydrogen, or a fuel cell coupled to a reforming system.

18. The method as claimed in claim 10, wherein the electric traction system comprises an electric machine configured to function in a motor mode and in a generator mode.
